(19) United States
(12) Patent Application Publication
(10) Pub. No.: US 2024/0327254 A1
(43) Pub. Date: Oct. 3, 2024

(54) ELECTROCHEMICAL WATER TREATMENT REACTOR AND WATER TREATMENT METHOD USING SAME

(71) Applicant: SK INNOVATION CO., LTD., Seoul (KR)

(72) Inventors: Yeon Hwa LA, Daejeon (KR); Tea Young LEE, Daejeon (KR); Hye Lin ROH, Daejeon (KR)

(21) Appl. No.: 18/618,619

(22) Filed: Mar. 27, 2024

(30) Foreign Application Priority Data
Mar. 31, 2023 (KR) 10-2023-0042555

(51) Int. Cl. C02F 1/463; C02F 1/461; C02F 101/34

(52) U.S. Cl. CPC C02F 1/463; C02F 2001/46133; C02F 2101/34

(57) ABSTRACT

According to one embodiment of the present disclosure, an electrochemical water treatment reactor includes a first cavity with a wastewater inlet, a second cavity with a wastewater outlet, a spacer disposed between the first and second cavities, the spacer separating the first and second cavities from each other, an anode disposed in the first cavity, a cathode disposed in the second cavity, and a metal powder disposed in the first cavity and being in direct or indirect contact with the anode. The reactor can be used to efficiently remove contaminants from wastewater without consuming the anode.

### CROSS REFERENCE TO RELATED APPLICATION

The present application claims priority to Korean Patent Application No. 10-2023-0042555, filed Mar. 31, 2023, the disclosure of which is incorporated herein by reference in its entirety.

### BACKGROUND OF THE DISCLOSURE

### 1. Field of the Disclosure

The present disclosure generally relates to an electrochemical water treatment reactor and a water treatment method using the same.

### 2. Description of the Related Art

An electrocoagulation-based water treatment process was developed in the 19th century and has been applied to a number of industrial wastewater treatment applications, most notably to the treatment of heavy metal wastewater or dyeing wastewater. Compared to water treatment using chemical coagulation in which coagulants are added directly to wastewater to coagulate the contained impurities, electrocoagulation-based water treatment has the advantages in that it does not require an additional coagulant feed, less sludge generation, and a wider pH range.

### SUMMARY

Various embodiments of the present disclosure relate to an electrochemical water treatment reactor and a water treatment method using the same.

An electrochemical water treatment reactor according to a first aspect of the present disclosure includes: a first cavity with a wastewater inlet; a second cavity with a wastewater outlet; a spacer disposed between the first and second cavities, the spacer separating the first and second cavities from each other; an anode disposed in the first cavity; a cathode disposed in the second cavity; and a metal powder disposed in the first cavity and being in direct or indirect contact with the anode.

According to an embodiment, the cathode may include Pt, stainless use steel (SUS), Fe, Al, Zn, Cu, Ti, Boron Doped Diamond (BDD), or a combination thereof.

According to an embodiment, the anode may include Pt, SUS, Fe, Al, Zn, Cu, Ti, BDD, or a combination thereof.

According to an embodiment, the electrochemical water treatment reactor may further include a metal powder disposed in the second cavity and being in direct or indirect contact with the cathode.

According to an embodiment, the metal powder may be derived from waste metal.

According to an embodiment, the metal powder may have a particle size of 1 to 20 mm in terms of the longest dimension thereof.

According to an embodiment, the metal powder may include Al, Fe, Cu, Zn, Ti, or a combination thereof.

According to an embodiment, the spacer may have a mesh shape.

An electrochemical water treatment method using the electrochemical water treatment reactor, according to an embodiment of the present disclosure, includes: supplying wastewater to the electrochemical water treatment reactor; applying electric power to the electrochemical water treatment reactor to generate a coagulant which coagulates contaminants contained in the wastewater to form aggregates; and supplying a metal powder to the electrochemical water treatment reactor according to consumption of the metal powder due to production of the coagulant.

The embodiments of the present disclosure provide an electrochemical water treatment reactor that can efficiently remove contaminants contained in wastewater without consuming an anode and can provide continuous wastewater treatment by not requiring replacement of the anode. The electrochemical water treatment reactor according to the embodiments of the present disclosure may efficiently remove microplastics from wastewater.

### BRIEF DESCRIPTION OF THE DRAWINGS

FIG. 1 is a schematic diagram of an electrochemical water treatment reactor according to one embodiment; and

FIG. 2 is a schematic diagram of an electrochemical water treatment reactor according to one embodiment.

### DETAILED DESCRIPTION OF THE EMBODIMENTS

The objectives, features, and advantages of the present disclosure will be more clearly understood with reference to the following detailed description and the accompanying drawings, but the present disclosure is not limited thereto. In the present disclosure, when the detailed description of the relevant known technology is determined to unnecessarily obscure the gist of the present disclosure, the detailed description may be omitted.

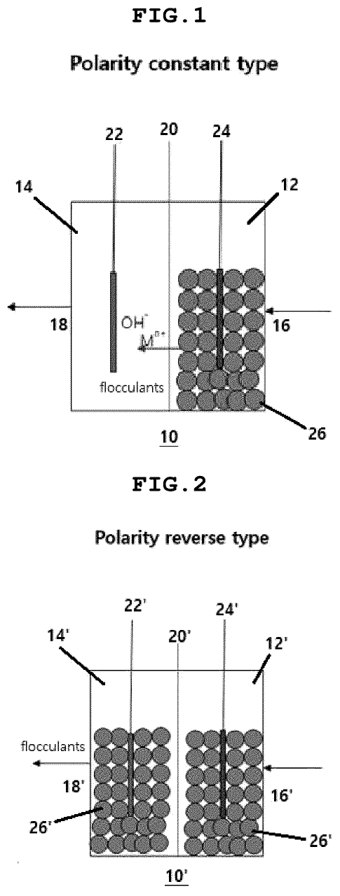

Referring to FIG. 1, there is provided an electrochemical water treatment reactor 10 according to an embodiment of the present invention including first and second cavities 12, 14 provided in the reactor; and a spacer 20 separating the first and second cavities 12 and 14 from each other. The first and second cavities 12, 14 may be formed by dividing the internal space of the reactor 10 into left and right regions. The first and second cavities 12, 14 may be separated by the spacer 20 disposed therebetween. The first cavity 12 may include a wastewater inlet 16 through which wastewater flows in from the outside, and the second cavity 14 may include a wastewater outlet 18 through which wastewater flows out from the reactor 10 to the outside.

The reactor 10 may include a cathode 22 positioned in the second cavity 14. The cathode 12 may be a reducing electrode that reduces when the reactor 10 is powered. The cathode 22 may not be eluted and consumed even when power is applied thereto. In other words, the material used as the cathode 22 may have a high electrical conductivity and a dissolution resistance to an electrolyte, and is not particularly limited provided that the material has such properties.

Suitable materials for the cathode 22 which provide high dissolution resistance to an electrolyte and high electrical conductivity include Pt, stainless use steel (SUS), Fe, Al, Zn, Cu, Ti, boron doped diamond (BDD), or a combination thereof. As described above, it is desirable for the material used as the cathode to have dissolution resistance to an electrolyte and high electrical conductivity, and Pt, SUS, Fe, Al, Zn, Cu, Ti, and BDD are metals that have both the dissolution resistance and high electrical conductivity. In an embodiment, the cathode may include SUS or Ti. In another embodiment, when the reactor is a polarity reversal type, the cathode may be changed to an anode and vice versa, in which case the cathode and/or the anode is a semi-permanent electrode. In such an embodiment, the cathode and anode may be made of Pt or BDD.

The electrochemical water treatment reactor 10 may include an anode 24 disposed in the first cavity 12. In a typical electrochemical water treatment reactor 10, the anode is generally consumed by an oxidation reaction by which metal ions contained in the anode elute when the reactor is powered. The metal ions form hydroxides which act as coagulants for contaminants. However, the anode 24 according to an embodiment of the present disclosure may have a high elution selectivity because the anode is in direct or indirect contact with the metal powders, and the metal powders that are located closer to the separator is located closer to the cathode 22, which is the counter electrode to the anode 24, than to the anode. Therefore, the anode 24 according to an embodiment of the present disclosure may not be significantly consumed when powered due to the anode's low elution selectivity relative to the metal powder's elution selectivity. The metal powder 26 in contact with the anode 24, particularly the metal powder that is located near the separator 20, may be consumed by oxidative elution in the form of metal ions Mⁿ⁺, which form hydroxides OH⁻ in wastewater and act as a coagulant.

According to an embodiment, the anode 24 may include Pt, SUS, Fe, Al, Zn, Cu, Ti, BDD, or a combination thereof. As described above, the anode according to an embodiment of the present disclosure may not be consumed by direct elution and may not be limited to highly reactive metals, such as the material conventionally used for the anode for an electrochemical agglomeration reactor. Instead, the anode according to an embodiment of the present disclosure may efficiently transfer an oxidizing charge to the metal powder that is in direct or indirect contact with the anode. According to the embodiments of the present invention, the anode may include Pt, SUS, Fe, Al, Zn, Cu, Ti, and BDD. In embodiments where the reactor is a polarization switching type, the anode may include Pt, SUS, Fe, Al, Zn, Cu, Ti, and BDD. The cathode and the anode are connected to and powered by the power supply.

The cathode and anode may have shapes of a plate or mesh. However, the shape of cathode and anode is not limited thereto. For example, the cathode and anode may have shapes of meshes or grids, rods or cylinders, tubular shape, spheres of beads, or some other irregular shape such a helix and the like.

The electrochemical water treatment reactor 10 may include disposed in the first cavity 12 metal powder 26 in direct or indirect contact with the anode 24. When the anode 24 is powered, the metal powder 26 in direct or indirect contact with the anode 24 may undergo oxidation, resulting in the elution of metal ions, instead of consuming the anode 24. The expression “metal powder in direct contact with the anode” means that the metal powder is attached to the surface of the anode, and the expression “metal powder in indirect contact with the anode” means that the metal powder is in contact with other metal powder that is in direct contact with the anode.

According to an embodiment, the electrochemical water treatment reactor may further include metal powder 26 that is disposed in the second cavity 14 and is in direct or indirect contact with the cathode 22 as illustrated in FIG. 2. When the reactor is a polarity-switching type reactor (also referred to as a polarity reverse type reactor) 50 as shown in FIG. 2, the cathode and the anode 22′, 24′ may be switched at regular intervals. As shown in FIG. 2, due to the presence of metal powder 26′ in both the first cavity 12′ and the second cavity 14′, even though the polarity of each electrode is switched, the metal powder 26′ in direct or indirect contact with the electrode corresponding to the anode may elute and produce a coagulant. Elements 20′, 16′ and 18′ in the polarity reverse type reactor 10′ of FIG. 2 correspond to the spacer 20, wastewater inlet 16, and wastewater outlet 18 of the polarity constant type reactor 10 of FIG. 1.

According to an embodiment, the metal powder may be derived from waste metal. As used herein, the term “waste metal” means metal components of wastes, including metals from any industry, and is not limited to metal components of wastes from a particular industry. In addition, the metal component of the waste may refer to metals discarded in the form of particles or powders generated in a process of physically recovering metallic components from the wastewater. Therefore, the reactor according to an embodiment of the present disclosure has the advantage of forming a coagulant on behalf of the anode without further processing. In addition, the reactor is eco-friendly because the metal powder derived from the waste metal acts as a consumable electrode from which metal ions are eluted to a coagulant instead of the anode, and is economically advantageous because there is no need to replace the anode since there is no consumption of the anode while the reactor is operating.

In an embodiment, the metal powder may have a particle size of 1 to 20 mm in terms of the longest dimension thereof. As described above, the metal powder is disposed in the first cavity isolated from the second cavity by the spacer. When the metal powder leaves the first cavity and flows into the second cavity, the contact between the anode and the metal powder may be inhibited, so that the transfer of oxidation charge from the anode to the metal powder is inhibited, resulting in reduction of the elution selectivity of the metal powder. To prevent this problem, the metal powder may be formed to have a size of at least 1 mm, in terms of the longest dimension thereof, which is larger than the size of a channel provided in the spacer so that the metal powder cannot flow from the first cavity to the second cavity through the channel. In addition, when the particle size of the metal powder is larger than 20 mm in terms of the longest dimension thereof, direct contact between the metal powder and the anode and/or contact between the metal powder in direct contact with the anode and the metal powder in indirect contact with the anode may be impaired, resulting in a loss of applied electrical energy. The spacer may have a plurality of the channels.

In an embodiment, the metal powder may include Al, Fe, Cu, Zn, Ti, or a combination thereof. In the reactor according to an embodiment of the present disclosure, the metal powder may act as a consumable electrode on behalf of the anode. Therefore, the metal powder may be a powder of a metal that is easily ionized by oxidation. As such, the metal powder may include Al, Fe, Cu, Zn, and Ti.

The reactor may include the spacer separating the first and second cavities from each other. As described above, the metal powder that is in direct or indirect contact with the anode disposed in the first cavity may not be able to elute and form an agglomerate upon power application when the metal powder is inhibited from making a direct or indirect contact with the anode. The spacer not only separates the first and second cavities from each other but also may include channels. The channels may allow metal ions and coagulants generated by oxidation of the metal powder to pass the spacer, but may not allow the metal powder to pass the spacer. Therefore, the channels may prevent the metal powder from exiting the first cavity and maintain the metal powder's direct or indirect contact with the anode, thereby preventing shortages that may occur when the anode and the cathode are electrically connected. The spacer may take any shape if the spacer can separate the first and second cavities from each other and has channels sized to prevent the passage of the metal powder but to allow the passage of metal ions and coagulants. In addition, for the stable operation of the reactor, the spacer may not have any effect on the electrical state of the cathode, anode, and metal powder, so the spacer may have insulating properties.

In an embodiment, the spacer may have channels having sizes of at least 100 μm and less than 1000 μm. When the metal powder exits the first cavity and enters the second cavity, electricity cannot be applied to the metal powder because the direct or indirect contact with the anode is not maintained. In this case, the agglomeration reaction may not occur easily despite when the power is applied. To prevent such issues, the spacer may have channels having a size smaller than the size of the metal powder to prevent the metal powder from escaping the first cavity. In an embodiment, the size of channels may be equal to or greater than 100 μm and less than 1000 μm. Specifically, the size of channels may be equal to or greater than 100 μm and equal to or less than 800 μm. More specifically, the size of channels may be equal to or greater than 100 μm and equal to or less than 500 μm.

In an embodiment, the spacer may have a mesh shape. The spacer having a mesh shape may separate the first and second cavities from each other and may have a plurality of uniform-sized channels.

An electrochemical water treatment method using the electrochemical water treatment reactor, according to an embodiment of the present disclosure, includes: supplying wastewater to the electrochemical water treatment reactor; applying electric power to the electrochemical water treatment reactor to generate a coagulant which coagulates contaminants contained in the wastewater to form agglomerates; and supplying a metal powder to the electrochemical water treatment reactor according to consumption of the metal powder by production of the coagulant.

The operation of supplying wastewater to the electrochemical water treatment reactor corresponds to the operation of supplying wastewater containing the contaminant to be removed to the first cavity of the electrochemical water treatment reactor as described above. In the wastewater supply operation, the wastewater may be supplied to flow from the first cavity to the second cavity through the spacer. Since the wastewater not only contains contaminants to be removed in the reactor but also serves as an electrolyte, when the wastewater is supplied to flow from the first cavity to the second cavity, an increase in power consumption attributable to fluid resistance between the cathode and the anode may be prevented.

The operation of applying power to the electrochemical water treatment reactor to generate a coagulant and to coagulate contaminants in the wastewater to form agglomerates corresponds to an operation of applying power to the cathode and the anode. In this operation, the metal powder in direct or indirect contact with the anode may be oxidized when the power is applied, and the oxidized metal powder may exist in the form of metal ions in the wastewater. The metal ions present in the wastewater may form hydroxides in the wastewater and act as coagulants causing the contaminants in the wastewater to agglomerate. As illustrated in FIG. 1, since the wastewater is supplied in a manner to flow from the first cavity to the second cavity, the contact of the coagulants with the contaminants may occur more frequently in the second cavity, and therefore, the agglomerates formed by coagulation of the contaminants by the coagulants may be mostly present in the second cavity. The agglomerates may be formed in a size larger than the channels of the spacer. When the agglomerates are formed in the second cavity, the agglomerates cannot flow back through the channels of the spacer into the first cavity. Therefore, the agglomerates may be prevented from interfering with direct or indirect contact between the metal powder and the anode.

The operation of supplying the metal powder to the electrochemical water treatment reactor according to the metal power consumption attributable to the formation of the coagulant corresponds to an operation in which the metal powder is supplied to the first cavity or, in the case of a polarization switching type reactor, the first and second cavities so that the metal powder acting as a consumable electrode on behalf of the anode continues to be consumed and to generate metal ions forming a coagulant after applying power to the reactor. In the case of a conventional electrocoagulation reactor in which the anode is a consumable electrode and is consumed as the electrocoagulation reaction proceeds, it is necessary to replace the anode before the entire anode is completely consumed, and the operation of the reactor needs to be stopped while the anode is replaced. However, in the case of the electrochemical water treatment reactor of the present disclosure, only the metal powder in direct or indirect contact with the anode may be consumed, and the anode may not be consumed. Therefore, the reaction may be maintained by periodically injecting the metal powder into the first cavity or into the first and second cavities so that only the metal powder remains in direct or indirect contact with the anode without stopping the operation of the reactor.

In an embodiment, the operation of supplying the metal powder may be further performed when the amount of the remaining metal powder is 10% to 20% of a predetermined amount. Here, the term “predetermined amount” refers to the amount of the metal powder that has been present in the first cavity or, in the case of a polarization switching type reactor, to the first and second cavities prior to the power application to the reactor. In theory, when even a trace amount of the metal powder in direct or indirect contact with the anode remains, metal ions may be eluted by the oxidation of the metal powder and thus a coagulant in the form of hydroxide may be formed. However, in order to constantly maintain the amount of coagulant production required for the coagulation reaction, thereby maintaining the stability of the coagulation reaction, the metal powder may be replenished when the amount of the remaining metal powder becomes 10% to 20% of the initially supplied amount of the metal powder.

In an embodiment, the predetermined amount may range from 15% to 85% by volume based on the volume of the first cavity or, in the case of polarity switching type reactor, the volume of the first and second cavities.

In an embodiment, the contaminants present in the wastewater may be microplastics. The microplastics may be present in wastewater generated from a process in which polyethylene terephthalate (PET) bottles are physically cleaned to recycle the PET bottles to as PET flakes for use as a raw material in fiber manufacturing. The microplastics may be dispersed in the wastewater due to the pulverization of the PET bottles during the physical cleaning process. The electrochemical water treatment method of the present disclosure may be particularly effective in coagulating the microplastics.

In an embodiment, the microplastics may have a size of 0.1 to 500 μm in terms of the longest dimension thereof. The microplastics may have a size of 1 to 250 μm in terms of the longest dimension.

The majority of the contaminants in the wastewater may be collected in the second cavity of the reactor in the form of agglomerates through the series of operations described above, and the treated wastewater containing the aggregates, i.e., the water to be treated, may be discharged to the outside through the wastewater outlet of the reactor. The discharged treated wastewater may be introduced to a filtration stage, and an effluent free of agglomerates and contaminants may be discharged from the filtrate stage.

Hereinafter, the examples according to various embodiments of the present disclosure may be described. However, the following embodiments are provided only to facilitate easier understanding of the present disclosure, and the present disclosure is not limited thereto.

### Example: Treatment of PET Cleaning Wastewater Using Waste Aluminum

As wastewater to be treated in an electrochemical water treatment reactor of the present disclosure, wastewater generated from a PET physical cleaning process was prepared, in which the wastewater contained a large amount of dispersed microplastic particles. The reactor was designed such that the anode and the cathode made of Pt were disposed in the first and second cavities, respectively, and aluminum powder recovered from the cathode material of a waste battery was fully charged into the first cavity in which the cathode was disposed. An insulating mesh spacer with a channel size of 7 μm was arranged between a first cavity and a second cavity to prevent the movement of the aluminum powder and to allow only ions, coagulants, and small-sized microplastic particles to pass through the spacer. The wastewater was supplied to the first cavity at a flow rate of 25 ml/s, and then, the wastewater was allowed to flow from the first cavity to the second cavity. A current of 0.06 A was then applied to the cathode and anode for 20 minutes, and after the 20 minutes of the current application, the aggregates in the wastewater were removed by filtration. For the filtered wastewater, the removal rate of microplastic particles was determined.

Specifically, the number of microplastic particles per volume of the wastewater was determined using Thermo iN10X Imaging IR (Ultra-fast Mapping mode Transmission, Imaging, Scan 1, Resolution 16) and the results are shown in Table 1 below.

TABLE 1

| | The number of |
|---|---|
| | microplastic particles |
| | (Count/L) |
| Wastewater before application of current | 96000 |
| Wastewater after application of current | 2500 |

As shown in Table 1 above, it is confirmed that with the reactor arrangement, approximately 97.4% of the microplastic particles present in the wastewater were coagulated and removed. In addition, it is also confirmed that there was no reduction in the weight of the platinum used in the anode after the application of the current. From the results, it can be seen that the electrochemical water treatment reactor according to an embodiment of the present disclosure may be used to achieve near-complete removal of contaminants present in wastewater while consuming only waste metals without consuming an anode.

Herein above, the present disclosure has been described in detail with reference to specific embodiments. Embodiments are intended to illustrate the present disclosure in detail, and the present disclosure is not limited thereto. It will be apparent to those skilled in the art that modifications thereto or improvements thereof are possible within the technical scope of the present disclosure.

It should be understood that the skilled person in the art may envision many other embodiments, and modifications and alterations of the example embodiments disclosed in the present disclosure which fall within the scope of the present disclosure as defined in the appended claims.

What is claimed is:

1. An electrochemical water treatment reactor comprising:
a first cavity with a wastewater inlet;
a second cavity with a wastewater outlet;
a spacer disposed between the first and second cavities, the spacer separating the first and second cavities from each other;
an anode disposed in the first cavity;
a cathode disposed in the second cavity; and
a metal powder being in direct or indirect contact with the anode and disposed in the first cavity.

2. The reactor of claim 1, wherein the cathode comprises Pt, stainless use steel (SUS), Fe, Al, Zn, Cu, Ti, boron doped diamond (BDD), or a combination thereof.

3. The reactor of claim 1, wherein the anode comprises Pt, SUS, Fe, Al, Zn, Cu, Ti, BDD, or a combination thereof.

4. The reactor of claim 1, further comprising a metal powder being in direct or indirect contact with the cathode and disposed in the second cavity.

5. The reactor of claim 1, wherein the metal powder is derived from waste metal.

6. The reactor of claim 1, wherein the metal powder has a particle size of 1 to 20 mm in terms of the longest dimension thereof.

7. The reactor of claim 1, wherein the metal powder comprises Al, Fe, Cu, Zn, Ti, or a combination thereof.

8. The reactor of claim 1, wherein the spacer has a mesh shape.

9. An electrochemical water treatment method using the electrochemical water treatment reactor of claim 1, the method comprising:
supplying wastewater to the electrochemical water treatment reactor;
applying electric power to the electrochemical water treatment reactor to generate a coagulant and to coagulate contaminants contained in the wastewater to form an agglomerate; and
supplying the metal powder to the electrochemical water treatment reactor according to consumption of the metal powder due to production of the coagulant.

10. The method of claim 9, wherein the supplying of the metal powder further comprises supplying the metal powder when an amount of the metal powder in the reactor is 10% to 20% of a predetermined amount of the metal powder.

11. An electrochemical water treatment reactor comprising:
a first cavity with a wastewater inlet;
a second cavity with a wastewater outlet;
a spacer disposed between the first and second cavities, the spacer separating the first and second cavities from each other;
an anode disposed in the first cavity;
a cathode disposed in the second cavity; and
a metal powder being in direct or indirect contact with the anode and disposed in the first cavity,
wherein the spacer includes channels.

12. The reactor of claim 11, wherein a size of the channels may range from 100 μm to 1000 μm.

13. The reactor of claim 12, wherein the channels have uniform size.
